(19) United States
(12) Patent Application Publication
(10) Pub. No.: US 2022/0301127 A1
(43) Pub. Date: Sep. 22, 2022

(54) IMAGE PROCESSING PIPELINE FOR OPTIMIZING IMAGES IN MACHINE LEARNING AND OTHER APPLICATIONS

(71) Applicant: Applied Materials, Inc., Santa Clara, CA (US)

(72) Inventor: Itai Leshniak, Sunnyvale, CA (US)

(73) Assignee: Applied Materials, Inc., Santa Clara, CA (US)

(21) Appl. No.: 17/205,416

(22) Filed: Mar. 18, 2021

(51) Int. Cl. G06T 5/20; G06T 1/20; G06T 3/40; G06T 7/11; G06T 3/60

(52) U.S. Cl. CPC G06T 5/20; G06T 1/20; G06T 3/40; G06T 7/11; G06T 3/608; G06T 2207/20081; G06T 2207/20084

(57) ABSTRACT

A system for optimizing images may include a camera sensor configured to capture a first image, and an image pipeline configured to receive the first image from the camera sensor. The image pipeline may identify a plurality of regions in the first image, and generate a second image from the plurality of regions in the first image. The second image may be smaller than the first image such that the second image can be more efficiently processed by a neural network. The system may also include a neural network configured to receive the second image from the image pipeline and train the neural network using the second image or process the second image using the neural network.

### TECHNICAL FIELD

This disclosure describes methods and systems for optimizing a camera image for processing by neural networks. More specifically, this disclosure describes methods and systems for extracting predefined regions from a camera image that may be rearranged and rotated to generate a smaller image for the neural networks to process.

### BACKGROUND

An Image Signal Processor (ISP), also known as an image processor, an image processing engine, or an image processing unit includes digital logic circuits that are configured to process images received from image sensors. For example, digital cameras or other digital imaging devices may include ISPs to process the raw images captured by imaging sensors. Image pre-processing and post-processing operations performed by the ISP may include black level correction, lens shading correction, dead pixel correction, chroma luma processing, edge enhancement, de-noise operations, image sharpening, downscaling, tone mapping, and/or other image operations. Although the operations performed by ISPs may be performed in software using a general purpose processor, ISPs are typically integrated in specialized integrated circuit hardware. This allows the ISP to employ parallel computing technologies with simple-instruction, multiple-data (SIMD) and multiple-instruction, multiple-data (MIMD) technologies to increase the speed and efficiency with which images may be processed.

### SUMMARY

In some embodiments, a system for optimizing images may include a camera sensor configured to capture a first image. The system may also include an image pipeline configured to receive the first image from the camera sensor; identify a plurality of regions in the first image; and generate a second image from the plurality of regions in the first image. The second image may be smaller than the first image. The system may also include a neural network configured to receive the second image from the image pipeline and train the neural network using the second image or process the second image using the neural network.

In some embodiments, a method of optimizing images may include receiving a first image from a camera sensor; identifying a plurality of regions in the first image; generating a second image from the plurality of regions in the first image, where the second image may be smaller than the first image; and providing the second image to a process that trains a model using the second image or processes the second image using the model.

In some embodiments, a non-transitory computer-readable medium may include instructions that, when executed by one or more processors, cause the one or more processors to perform operations including receiving a first image from a camera sensor; identifying a plurality of regions in the first image; generating a second image from the plurality of regions in the first image, where the second image may be smaller than the first image; and providing the second image to a process that trains a model using the second image or processes the second image using the model.

In any embodiments, any and all of the following features may be implemented in any combination and without limitation. The image pipeline may include an image pre-processor, an image post-processor, and a memory that stores the first image and the second image. The system may include one or more processors that receive the second image from the neural network or the image pipeline. A portion of the image pipeline that generates the second image may be implemented in digital logic of an integrated circuit. A resolution of the first image may be substantially the same as a resolution of the second image. A size of the second image may be less than one tenth of a size of the first image. Locations of the plurality of regions in the first image may be predetermined prior to the first image being processed by the image pipeline and based on locations in a scene captured by the camera sensor. The locations in the scene captured by the camera sensor may include objects that the neural network is trained to identify. Generating the second image may include rearranging locations of the plurality of regions from the first image to new locations in the second image. Generating the second image may include scaling at least one of the plurality of regions in the second image. Generating the second image may include storing a default value in remaining pixels in the second image that are not used by the plurality of regions. Generating the second image may include extracting pixels inside the plurality of regions in the first image, and inserting the pixels into the second image. The second image may exclude pixels in the first image that are outside of the plurality of regions. A shape of the second image may be selected based on a shape for which the model is optimized. Generating the second image may include applying a skew transform to at least one of the plurality of regions to correct a perspective difference between the plurality of regions. At least one of the plurality of regions may include a cutout. The method/operations may also include providing the second image to the model to identify features in the second image. The plurality of regions in the first image may be defined as areas in the view of the camera sensor that are likely to include objects that are recognized by the model.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates an image captured by a camera sensor, according to some embodiments.

FIG. 2 illustrates an image pipeline, according to some embodiments. The camera sensor may be external to the image pipeline.

FIG. 3 illustrates how an image may be optimized using known areas of interest, according to some embodiments.

FIG. 4 illustrates an image pipeline that includes a circuit for optimizing the image provided to the neural networks, according to some embodiments.

FIG. 5 illustrates a first image of a traffic scene, according to some embodiments.

FIGS. 6A-6D illustrate second images that may be generated from the first image of the traffic scene, according to some embodiments.

FIG. 7 illustrates another example of a first image of a shopping area, according to some embodiments.

FIG. 8 illustrates a second image generated from the plurality of regions according to some embodiments.

FIG. 9 illustrates a first image of a shopping area from an overhead view, according to some embodiments.

FIG. 10 illustrates a second image using the plurality of regions from the first image 900 of the shopping area, according to some embodiments.

FIG. 11 illustrates a first image of an area around an assembly line, according to some embodiments.

FIG. 12 illustrates a second image generated from the region in the first image of the assembly line, according to some embodiments.

FIG. 13 illustrates a flowchart of a method for optimizing images, according to some embodiments.

FIG. 14 illustrates an exemplary computer system, in which various embodiments may be implemented.

### DETAILED DESCRIPTION

Neural networks another machine learning models may process images to identify specific features. However, full-sized, high-resolution images are too large to be efficiently processed and stored in an image pipeline. Existing image pipelines have reduced the resolution and size of the camera images to reduce the compute power and memory required to store and process these images in the pipeline. However, lowering the resolution and size of the image negatively affects the accuracy with which a neural network can process the image.

Instead of reducing the pixel resolution of the image, the embodiments described herein efficiently focus the neural networks on the areas of interest with in the image captured by the camera. The images captured by a camera are often very large compared to the areas of interest within the image where these features may occur. Because the cameras often stationary, these areas can be predefined before image processing takes place. When an image is captured by the camera, these predefined regions can be extracted from the camera image and used to generate a second image that can be more efficiently processed by the neural networks. Specifically, pixels in the regions from the camera image may be extracted and rotated, rearranged, etc., to form a smaller second image that maintains the original pixel resolution of the regions in the camera image. The second image can also be shaped such that it can be more efficiently processed by the neural networks (e.g., in a long rectangular shape). These operations can be carried out in the digital logic hardware of the image pipeline without requiring per-image operations by the CPU. Although the resulting second image may appear strange to a human user, the neural networks are not affected by the rotation and rearranging of regions within the second image. These embodiments leverage this flexibility in how neural networks process images to improve their performance without sacrificing image quality.

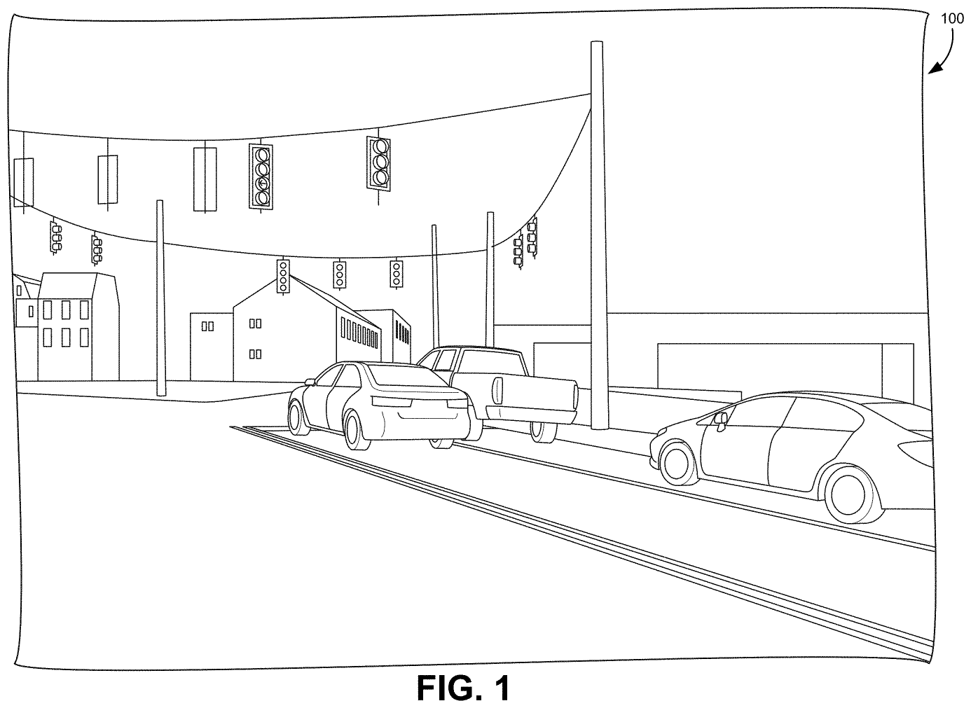

FIG. 1 illustrates an image 100 captured by a camera sensor, according to some embodiments. The image 100 may be captured from a camera sensor that is stationary as opposed to a camera sensor that is mobile. For example, mobile camera sensors may be used on electric vehicles and handheld camera equipment. In contrast, stationary camera sensors may be mounted to fixed objects and configured to capture one or more predefined views of a surrounding area. In this example, the image 100 may be captured from a traffic or surveillance camera that is mounted to a fixed surface, such as the wall of a building or a telephone pole. The view captured an image 100 may be one of a plurality of predefined views that are programmed into the camera. For example, the camera may be outfitted with pan/tilt/rotate/zoom controls that allow the camera to move between any of a number of predefined views.

Because the camera sensor of a stationary camera may capture images based on one or more predefined views, areas of the image 100 in which objects of interest may be captured may be known before the image 100 is captured. Existing image processing techniques start with the image 100 and perform computer vision algorithms on the image 100 in order to identify objects of interest. However, the embodiments described herein leverage the predefined views that are captured by the camera sensor in order to focus the processing operations on the portions of the image 100 that are known to be of interest to the image processing. In this example, the image 100 may be captured for the purpose of identifying behavior of automobiles at an intersection. Therefore, certain areas of the street, sky, trees, and other surrounding scenery may be of little interest to an image processing algorithm. Instead, such an algorithm would tend to focus on the area of the street where a car is likely to stop at the intersection, as well as the area of the image 100 capturing a view of the traffic lights. Algorithms, models, or neural networks used in machine learning techniques may be trained to identify cars and/or traffic lights. However, without optimizing the image 100 as provided by the camera sensor, these machine learning techniques would need to handle the entire image 100.

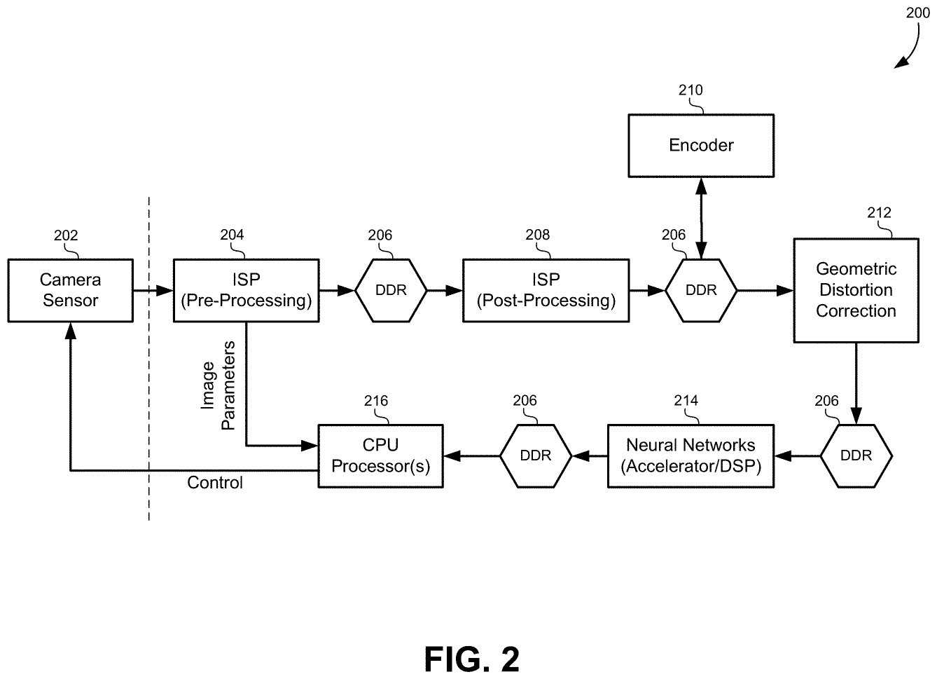

FIG. 2 illustrates an image pipeline 200, according to some embodiments. The camera sensor 202 may be external to the image pipeline 200. The camera sensor may include any known camera sensor available in the art, including CMOS imaging sensors that convert received wavelengths of light—both visible and invisible to the human eye—into currents and/or voltages for each pixel in the captured image. The camera sensor may provide the image as a 2D array of pixels having color values. The camera sensor 202 may operate on a separate integrated circuit than the rest of the image pipeline 200. Additionally, the image pipeline 200 may also be commonly referred to as an Image Signal Processing (ISP) pipeline or circuit.

The image pipeline 200 may also include a preprocessing circuit 204. The pre-processing circuit 204 may perform operations such as black level correction to adjust the brightness level of the image based on the darkest portion of the image. The pre-processing circuit 204 may also perform lens shading correction to correct the shading of the image. The pre-processing circuit 204 may also perform dead pixel correction to identify and color pixels corresponding to malfunctioning sensors in the camera sensor. The pre-processing circuit 204 may also perform demosaicing to generate full-color images from incomplete color sample outputs from the camera sensor. The pre-processing circuit 204 may additionally perform other image processing algorithms not specifically listed herein.

After the pre-processing circuit 204 processes the image, the image may be stored in a memory 206. In this example, a double data rate (DDR) random-access memory (RAM) may be used to store the image. The overall size of the image may cause reading/writing to the memory 206 to become a performance bottleneck in the image pipeline 200. As illustrated in FIG. 2, each step in the image pipeline 200 may involve reading and/or writing the image to/from the memory 206. As the length and/or width of the image increases, the area and number of pixels will increase a geometric rate (e.g., Δ width×Δ length). The time required to read/write the memory 206 may thus increase the overall time required to process an image in the image pipeline 200. The size of the image may also require more memory, which in turn requires more power and circuit area for the memory 206 to accommodate larger image sizes.

The image pipeline 200 may also include a post-processing circuit 208 that performs operations such as processing chrominance and luma components for colors in the image. The post-processing circuit 208 may also perform edge enhancement to sharpen edges in the image. The post-processing circuit 208 may also filter noise from the image and/or sharpen blurry areas of the image. The post-processing circuit 208 may provide tone mapping operations and/or gamma correction for the image 100. In some implementations, the post-processing circuit 208 may downscale the image. As described above, the overall size of the image may be the main cause of most processing bottlenecks. Therefore, some implementations may reduce the size of the image by downscaling the image. Numerous techniques are available for downscaling an image, such as pixel combination, pixel averaging, and so forth.

Some implementations of the image pipeline 200 may include an encoder that compresses the video stream. Various codecs may be used, including H.264, H.265, and others. A geometric distortion correction circuit 212 may be used to remove distortion introduced due to wide field-of-view characteristics of the image.

At this stage, the image may be ready for processing by a neural network 214. Note that a neural network 214 is used in FIG. 2 only by way of example and is not meant to be limiting. Other embodiments may use other types of models or image-processing algorithms. The neural network 214 may be considered one specific type of model that may be trained using training data, such as the image 100 from FIG. 1, to recognize image elements in future images provided to the image pipeline 200. The neural network 214 may receive the image and either be trained using the image or process the image to identify specific image characteristics. For example, the image in FIG. 1 may be used to train the neural network 214 to identify elements such as automobiles and/or traffic lights. After the neural network 214 has been trained, the neural network 214 may be used to identify elements in that image 100. For example, instead of using the image 100 to train the neural network 214 to identify traffic lights, the traffic lights in the image 100 may be recognized by the neural network when providing the image 100 as an input. Some embodiments may use a plurality of neural networks, such that each neural network is trained to recognize specific elements in the image. For example, one neural network may be trained to recognize traffic lights, while another neural network may be trained to recognize automobiles.

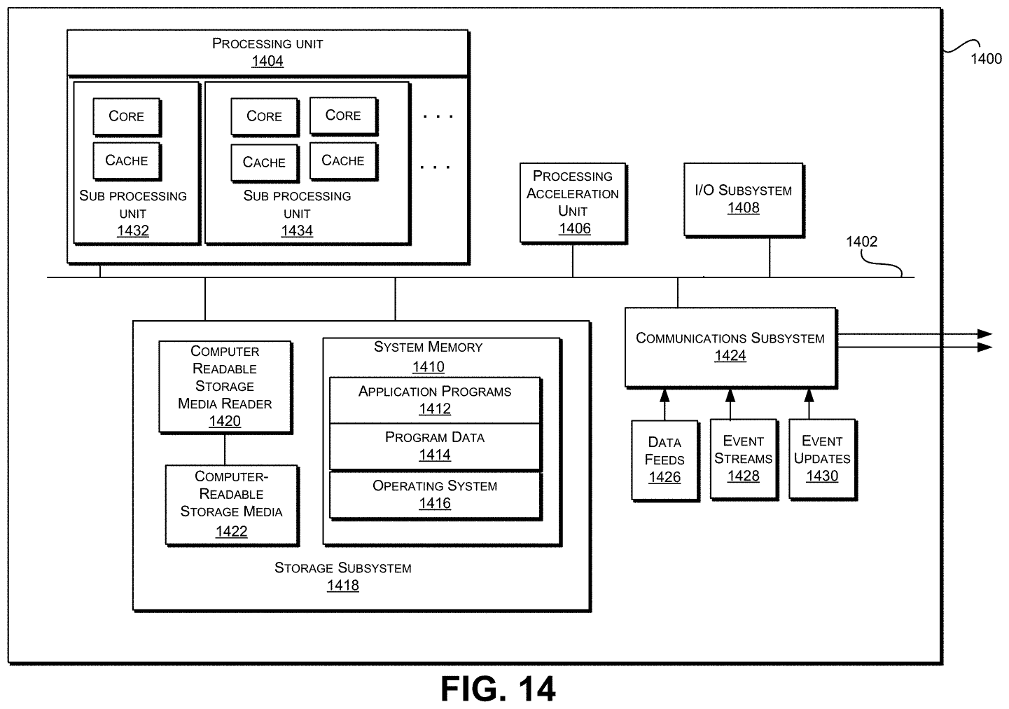

The image pipeline 200 may also include one or more processors. The one or more processors may be implemented by a general purpose central processing unit (CPU) 216 that executes software instructions. The instructions may be stored on a non-transitory, computer-readable medium that may cause the one or more processors to perform certain operations. An example of one or more processors executing instructions on a storage medium are described in detail below in FIG. 14. The CPU 216 may receive image parameters from the image pipeline 200 and provide control signals to the camera sensor 202. The operations performed by the CPU 216 may be distinguished from the operations performed from digital hardware of the rest of the image pipeline 200. Specifically, software operations performed by the CPU 216 are different from the hardware functions that are carried out by the digital circuits of the rest of the image pipeline 200. For example, the CPU 216 may include a processor core that executes software instructions, while the rest of the image pipeline 200 may be implemented using digital circuits designed in a hardware language, such as VHDL, and implemented in programmable hardware (e.g., an FPGA) or a dedicated integrated circuit (e.g., an ASIC). The hardware functions performed by the rest of the image pipeline 200 may be carried out in parallel, use less power, and may be executed faster than the software instructions executed by the CPU 216 for an image as a whole. Some embodiments may also consider the CPU 216 to be separate and distinct from the image pipeline 200, possibly being implemented on a different integrated circuit.

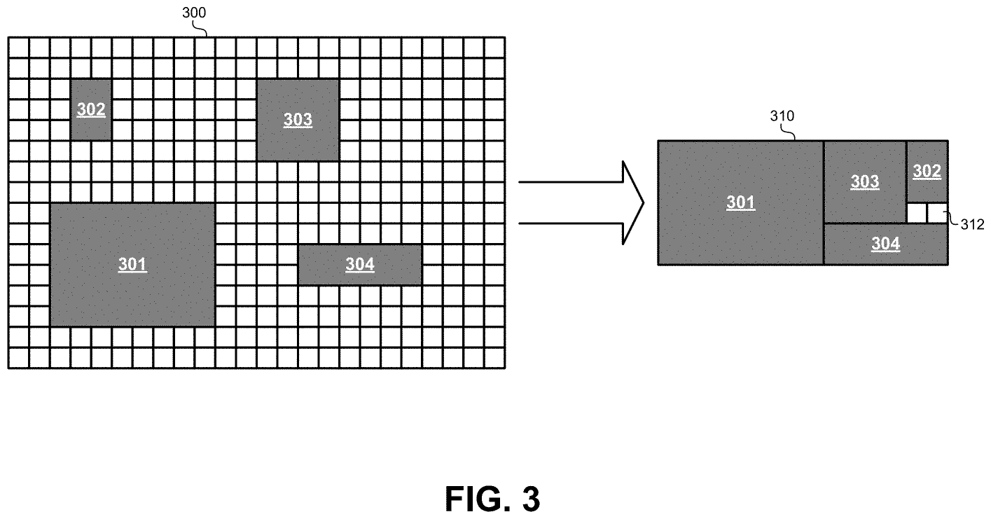

FIG. 3 illustrates how an image may be optimized using known areas of interest, according to some embodiments. A first image 300 may represent an image provided from the camera sensor. The first image 300 may have been processed by the pre-processing circuit 204 and/or the post-processing circuit 208. As described above, high-definition, high-resolution images, such as the first image 300, require a large amount of compute power when being processed by the neural network or other models in the image pipeline. However, the embodiments described herein may optimize the size and/or arrangement of the first image 300 without sacrificing the resolution of the image provided to the neural network.

As described above, areas of interest in the first image 300 may be known before being processed by the image processing pipeline. In contrast to previous solutions that use the image pipeline to identify areas of interest, these embodiments may reduce the size of the image by extracting the areas of interest and generating a new image. For example, instead of processing the entire first image 300 using a neural network to identify the location of a traffic light, the location of the traffic light may instead be known beforehand based on the view of the image captured by the camera sensor. After the camera is installed in a physical location, a human operator and/or machine learning algorithm may identify the location of the traffic light, the location of the automobile(s) at the intersection, etc., in a resulting image and provide the coordinates of those locations to the image pipeline. The image pipeline may then extract those areas of interest using the coordinates from future images as they are received and generate new images that exclude areas that are not of interest.

In this example, the first image 300 may include a plurality of regions 301, 302, 303, 304 in the first image 300. These regions 301, 302, 303, 304 may have been previously identified as likely to include views of objects of interest by a human input or by a computer vision algorithm configured to recognize such objects. These regions 301, 302, 303, 304 may be defined by bounding boxes around locations where the objects of interest have been seen in previous images from the camera sensor. The bounding boxes may be defined by corner or boundary vertex coordinates. For example, a region 301 may be defined by a first coordinate of a lower left corner of the bounding box and by a second coordinate of an upper right corner of the bounding box. Note that the regions 301, 302, 303, 304 in this example are rectangular only by way of example. As described below, other bounding boxes may include polygons or other shapes that are defined by vertex coordinates or other shape definitions (e.g., a vertex and radius of a circle) that are nonrectangular to include any shape.

The pixels inside the regions 301, 302, 303, 304 may be extracted from the first image 300 and used to generate a second image 310. The second image may be generated such that it includes the pixels from the first image 300 in the regions 301, 302, 303, 304 and excludes pixels from the first image 300 not in the regions 301, 302, 303, 304. Any remaining pixels 312 in the second image 310 that are not filled using pixels from the first image 300 in the regions 301, 302, 303, 304 may be filled with a default value, such as ‘0’.

The general shape of the second image 310 may be selected based on the neural networks that will process the second image 310. For example, some neural networks may be optimized to process square images. Other neural networks may be optimized to process longer, rectangular images. Some neural networks may also be optimized to use different default values for the remaining pixels 312. These optimizations for the neural network(s) may be used to determine an overall shape for the second image 310.

When the shape of the second image 310 has been determined, various algorithms may be used to fit the regions 301, 302, 303, 304 into the predetermined shape of the second image 310. For example, some embodiments may use a first-fit algorithm that sorts the regions 301, 302, 303, 304 based on size and then fills in the second image 310 starting with the largest regions first. As described below, some embodiments may allow the regions 301, 302, 303, 304 to be scaled and/or rotated to better fit within the overall shape of the second image 310. The algorithm may rotate shapes and cycle through various placements until a number of remaining pixels 312 left in the second image 310 is minimized. Alternatively, a user input may specify locations for the regions 301, 302, 303, 304 in the second image 310.

Scaling some of the regions may be done to efficiently fill the second image 310 without sacrificing the resolution of the pixels in the regions 301, 302, 303, 304. For example, some embodiments may only allow regions to be scaled up rather than being scaled down to a lower resolution. An example of such scaling is described in detail below. However, an advantage of the second image 310 is that the resolution of the portions of the first image 300 used to create the second image 310 can maintain their full resolution. Instead of downsizing the first image 300 to reduce the processing/memory requirements for providing the first image 300 to a neural network, the second image 310 may be used, which has a much smaller size without sacrificing pixel resolution.

Rearranging the locations of the regions 301, 302, 303, 304 and rotating/scaling the regions 301, 302, 303, 304 may produce a second image 310 that looks odd to human users, but which does not affect the operation of the neural networks. Generally, models used in machine learning and artificial intelligence do not depend on the location of features in an image. Instead, they are able to process the entire image to find image features regardless of their location and/or orientation. Therefore, these embodiments leverage this feature of neural networks to optimize the second image 310 to allow the regions 301, 302, 303, 304 to be rearranged, scaled, and/or rotated. This decreased image size of the second image 310 saves time and increases throughput for memory access, video encoding, geometric distortion correction, and neural network processing. In some embodiments, the first image 300 may be distinguished from the second image 310 and that the second image 310 is smaller in size than the first image 300. For example, some embodiments may generate a second image that is less than 1/10 the size of the first image. This reduction size may be accomplished while the resolution of the first image remain substantially the same as the resolution of the second image.

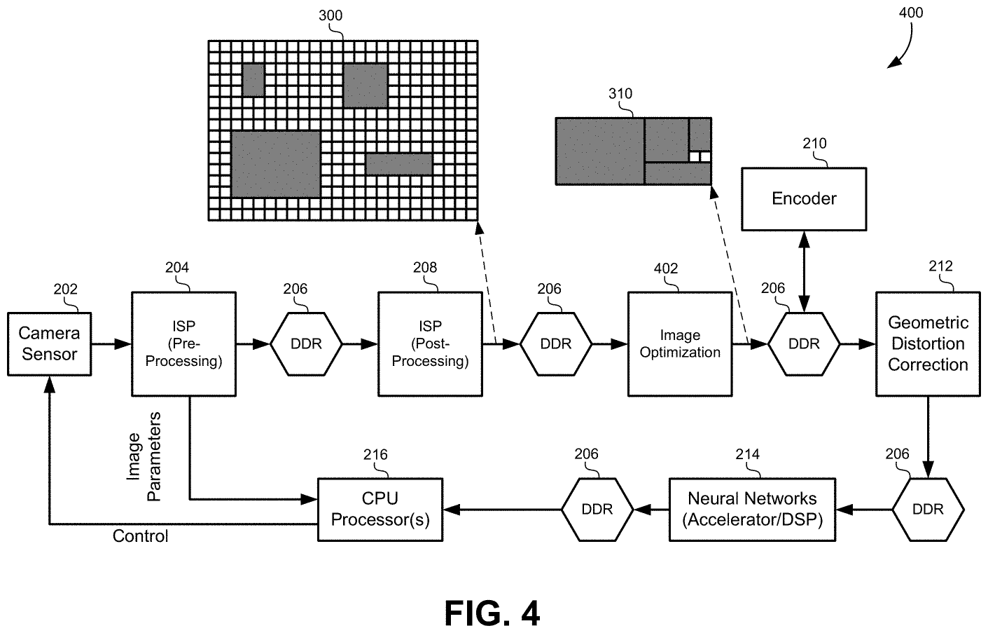

FIG. 4 illustrates an image pipeline 400 that includes a circuit for optimizing the image provided to the neural networks, according to some embodiments. This image pipeline 400 is similar to the image pipeline 200 illustrated in FIG. 2, a difference being that this image pipeline 400 includes an image optimization circuit 402 after the post-processing circuit 208 and before the video stream is encoded or corrected for geometric distortion. Placing the image optimization circuit 402 at the depicted location in FIG. 4 represents only one of many possible architectures for the image pipeline 400. Other embodiments may move the image optimization circuit 402 to other locations in the image pipeline 400, including between the pre-processing circuit 204 and the post-processing circuit 208, after the geometric distortion correction 212, and/or the like.

It may be advantageous to include the operations performed by the image optimization circuit 402 in the hardware portion of the image pipeline 400. This may be contrasted to optimizing the image in the software operations of the CPU 216. In some embodiments, the CPU 216 may receive the locations (e.g. coordinates) of the regions in the first image 300, and provide the locations of the regions to the image optimization circuit 402. This may be done during a set up or initialization routine for the image pipeline 400. Thus, as images are continuously processed from the camera sensor 202, the CPU 216 is not required to participate in the operations of the image optimization circuit 402. Instead, the CPU 216 may provide parameters to the image optimization circuit 402 during initialization or startup, and the image optimization circuit 402 may operate independently thereafter. Parameters provided from the CPU 216 to the image optimization circuit 402 may include coordinates or locations for the regions of interest in the first image 300, shapes of the second image 310 for which the neural networks 214 have been optimized, placement of regions within the second image 310, and so forth. For example, the CPU 216 may execute the algorithm described above to optimize the placement of regions from the first image 300 into the shape of the second image 310, and then may provide those locations to the image optimization circuit 402 to process a stream of images provided from the camera sensor 202.

Alternatively, some embodiments may perform the image optimization operations using one or more processors, such as the CPU 216. For example, the CPU 216 may be programmed to receive the first image from the camera sensor, identify the plurality of regions in the first image, and generate a second image from the plurality of regions in the first image. These embodiments may be useful when the neural networks and/or other computer vision algorithms are executed separately from the image pipeline 400.

In order to illustrate different ways in which the second image may be generated, the following figures in description illustrate different types of first images that may be processed to reduce their size for neural network processing. These figures are provided only by way of example and are not meant to be limiting. Instead, the principles illustrated below in generating these second images may be adapted to cover a wide range of different image processing applications.

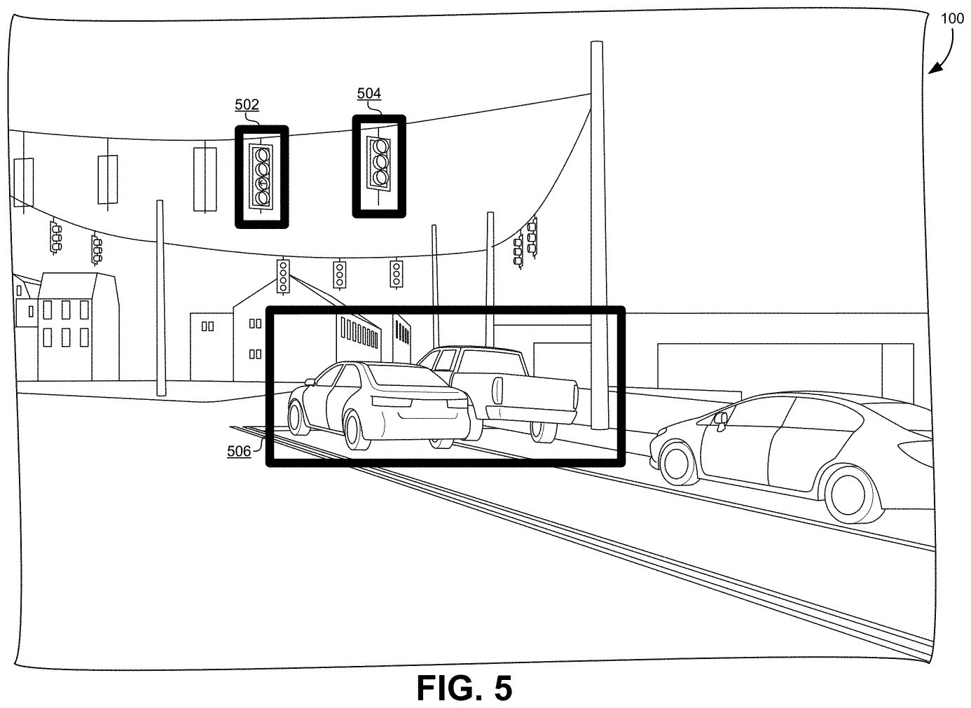

FIG. 5 illustrates a first image of a traffic scene, according to some embodiments. This image 100 was previously discussed in FIG. 1. However, in this image a plurality of regions of interest have been highlighted within the image 100. For example, regions 502, 504 include views of traffic lights. Region 506 includes a view of vehicles stopped at the intersection. These regions 502, 504, 506 may have been previously identified for the camera sensor in its current position. Thus, when the image 100 is received by the image optimization circuit described above, the image optimization circuit may extract the pixels from these regions 502, 504, 506 in the image 100 to generate a second image.

Note that no additional processing is required to define the regions 502, 504, 506 at runtime. Instead, these regions 502, 504, 506 may have been previously defined and provided to the image optimization circuit by the CPU as described above. For example, although the image 100 depicted in FIG. 5 shows automobiles in the region 506 at the intersection, this may not always be true for every image captured by the camera sensor during a live video stream. For example, an image taken by the camera sensor one minute later may include no automobiles in the region 506 if no automobiles are stopped at the intersection. However, the view within the region 506 would still be defined as a region of interest and as one most likely to have a view of automobiles stopped at the intersection.

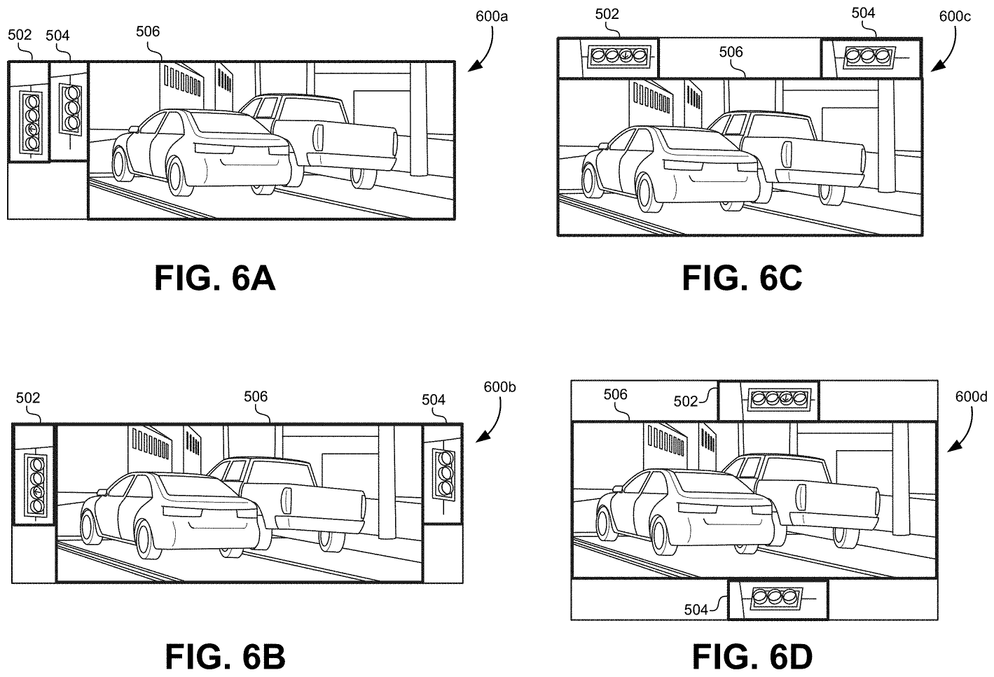

FIGS. 6A-6D illustrate second images that may be generated from the first image 100 of the traffic scene, according to some embodiments. The locations of the regions 502, 504, 506 may be rearranged relative to each other in the second images 600a-d. For example, the second image 600a in FIG. 6A places the regions 502, 504 with the traffic lights next to the region 506 with the view of the automobiles. Similarly, the second image 600b in FIG. 6B places the regions 502, 504 on either side of the region 506. The second images 600c and 600d in FIGS. 6C-6D rotate the regions 502, 504 ninety degrees. The rotated regions 502, 504 may then be placed on the top and/or bottom of the region 506.

The second images 600a-d maybe generated when the neural networks are optimized to process a longer rectangular image. Although not shown explicitly in FIGS. 6A-6D, other embodiments may generate a second image that is more square when the neural networks are optimized to process square images. A more square image may be generated by placing the regions 502, 504 on the top/bottom of the region 506 without rotating the regions 502, 504. Any remaining pixels in the second images 600a-d may be filled in with a default value, such as 0's for the remaining pixels. In this embodiment, no information outside of the regions 502, 504, 506 from the first image is included in the second image, although this is not necessarily required. Other embodiments may use pixels from the first image 100 to fill in any remaining space in the second image. Alternatively, a default value (such as ‘0’) may be used to simplify the multiplications in multiply-accumulate (MAC) operations.

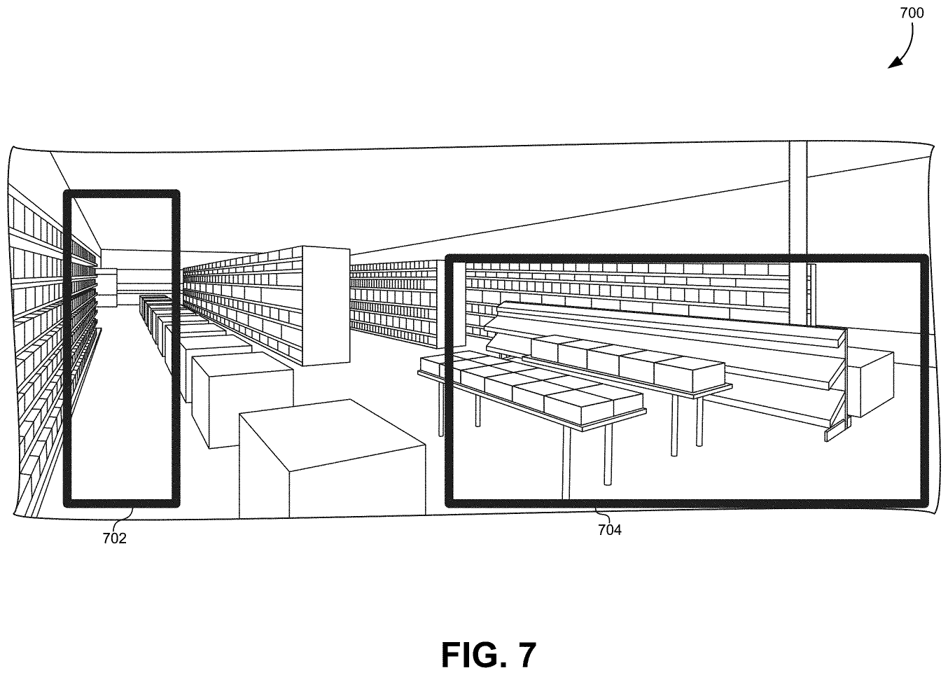

FIG. 7 illustrates another example of a first image 700 of a shopping area, according to some embodiments. The areas where people are likely to be seen have been highlighted as regions of interest in the first image 700. This may include a view down an aisle in region 702, as well as a view of a produce area where shoppers may stand in region 704. The views of other areas in the first image 700 may be of less interest when identifying behaviors of users in the shopping area. Thus, the views of shelves, ceilings, and floors where shoppers are less likely to be seen may be excluded from the plurality of regions 702, 704.

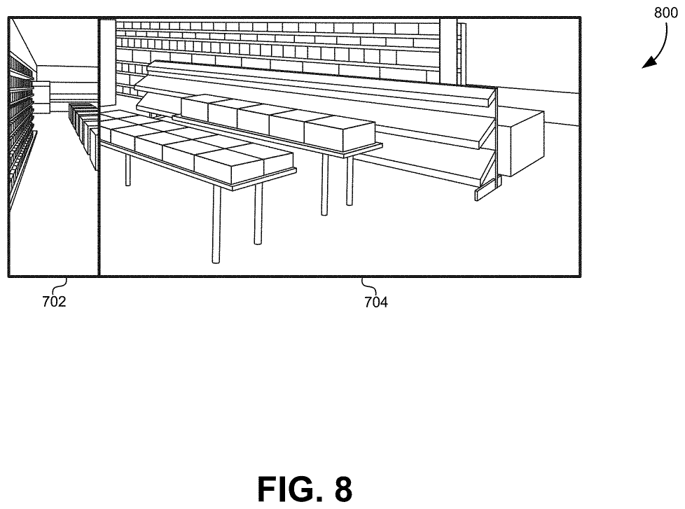

FIG. 8 illustrates a second image 800 generated from the plurality of regions 702, 704, according to some embodiments. Referring back to FIG. 7, the heights of region 702 and region 704 need not be equal. Specifically, region 702 may be taller than region 704. Some embodiments may optimize the area in the second image 800 by scaling one or more of the plurality of regions to fill remaining any space in the second image 800. In this example, region 702 may be scaled down to have a height that is equal to the height of region 704. Alternatively, the height of region 704 may be scaled up to have a height that is equal to the height of region 702. This allows the two regions 702, 704 to be stitched together into a rectangular shape that eliminates any unused pixels. Note that scaling regions in the second image 802 does not affect the ability of neural networks to identify objects (e.g., shoppers) in those regions.

The algorithm described above that is used to arrange the regions 702, 704 within the second image 800 may additionally scale regions to find a best fit within the shape of the second image 800. For example, a tallest region, such as region 702, may be identified and placed first in the second image 800. Each subsequent region may be scaled up to have a height equal to the height of region 702, and the scale regions may be added incrementally to the second image 800 to form a rectangular shape. Other shapes for the second image 800 may also scale regions to find a best fit. For example, the first-fit algorithm described above may be used to fit regions into a square shape, and regions may then be scaled up to fill any unused space in the second image.

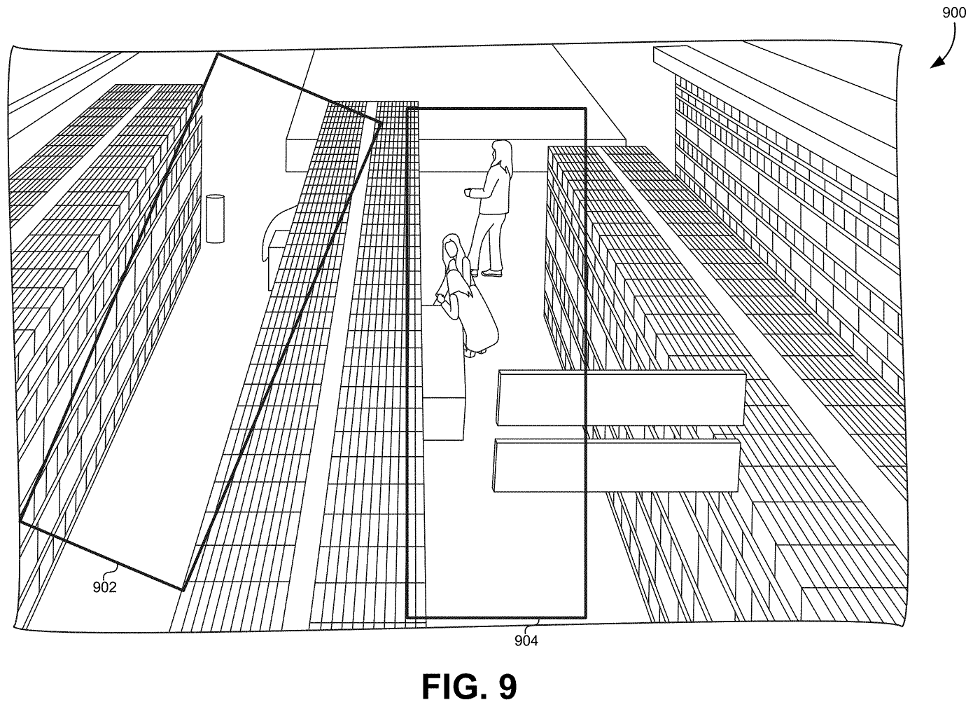

FIG. 9 illustrates a first image 900 of a shopping area from an overhead view, according to some embodiments. As described above in relation to FIG. 7, the regions of interest may focus on views of aisles where shoppers may be located and identified, as opposed to views of shelves, groceries, and other areas where shoppers are unlikely to be located. Regions 902, 904 may be defined to include views of the aisles in the shopping area.

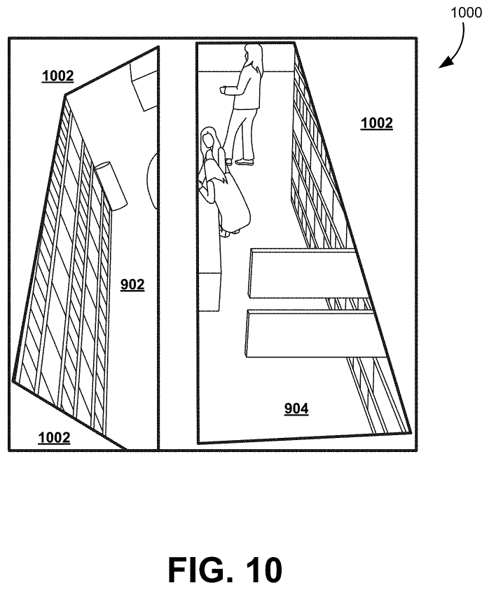

FIG. 10 illustrates a second image 1000 using the plurality of regions from the first image 900 of the shopping area, according to some embodiments. Because the view of the camera sensor in the first image 900 captures the aisle depicted in region 902 at a skewed angle compared to the direct view provided by the aisle in region 904, a perspective correction may be used to cause the views in both regions 902, 904 to be more similar. For example, a skew transform may be applied to region 902 to lengthen one side of the region 902 relative to the other side of the region 902. This may cause the view of the aisle in region 902 to appear to be more of an overhead view than in the original first image 900. Thus, in addition to scaling, rotating, and rearranging the positions of regions in the second image 1000, some embodiments may also apply various other transforms such as skew transforms, etc., to regions when generating the second image 1000.

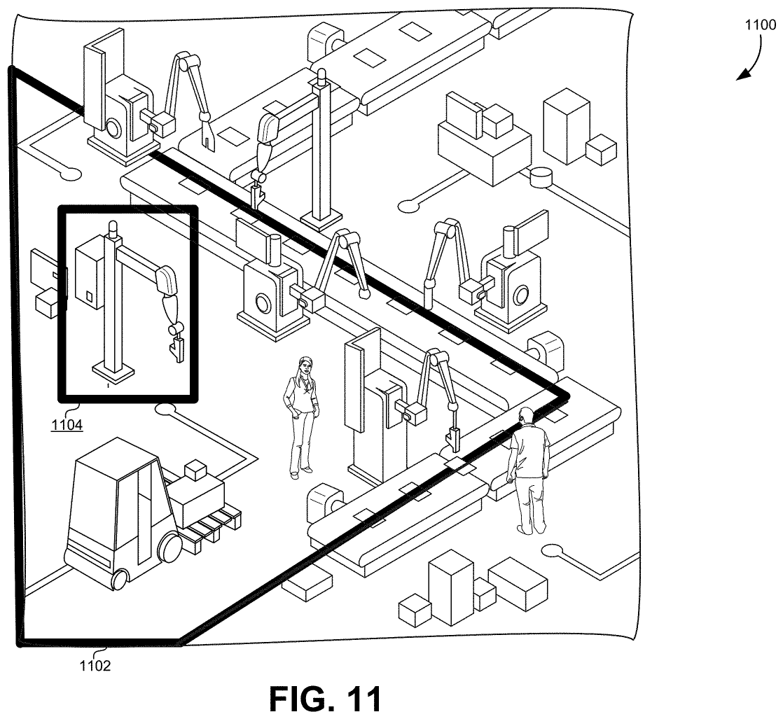

FIG. 11 illustrates a first image 1100 of an area around an assembly line, according to some embodiments. The first image 1100 may be recorded from a security or safety camera to monitor worker actions in the assembly line area. A neural network may be trained to recognize worker actions or worker positions in the assembly line area for safety and/or security reasons. Again, portions of the first image 1100 may be excluded from processing by the neural networks when they are unlikely to include views of workers performing a type of action being monitored. In this example, a single region 1102 may be identified to monitor workers performing a particular type of task.

Instead of using a rectangular region as used in the examples described above, the region 1102 may be bounded by an irregular shape. The polygon that defines the boundary around area 1102 may be defined by a plurality of vertex coordinates that specify line segments around the region 1102. Region 1102 also includes a cutout 1104 that excludes an area inside of the region 1102. A separate polygon may be specified to define the boundaries of the cutout 1104. Although only a single cutout as shown in FIG. 11, any number of cutouts may be used. The combination of the cutout 1104 and the boundary of region 1102 may still be considered a single region. This example illustrates how any number of polygons may be used to define a region, and how polygons may have any shape.

Although straight-line segments defined by vertex coordinates are used in this example to define the boundaries of the region 1102, other embodiments may use other shape definitions to define polygon boundaries. For example, circular boundaries may be defined using a center point and a radius. Similar definitions may be used to define ovals, parabolic regions, combinations of straight lines and arcs, and so forth. Any combination of lines, arcs, or other geometric shape definitions may be used alone or in combination to define regions in the first image.

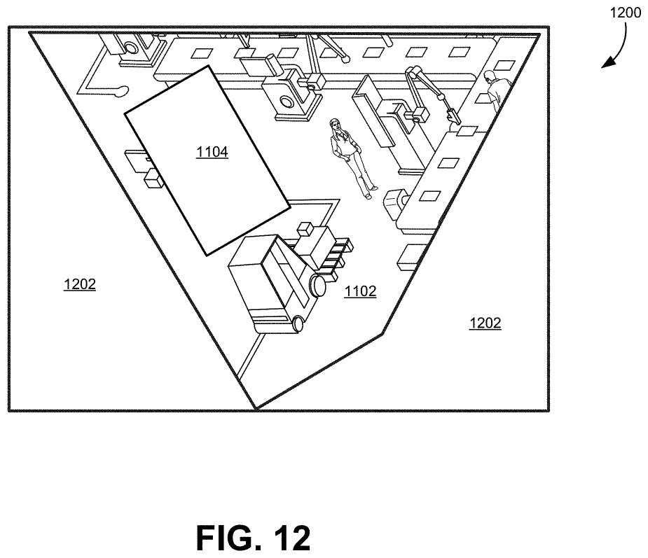

FIG. 12 illustrates a second image 1200 generated from the region 1102 in the first image 1100 of the assembly line, according to some embodiments. This example shows how a single region 1102 may be used to generate the second image 1200. Even using a single image 1102 may significantly optimize the processing performed by the neural networks. For example, an irregular shape for the region 1102 may be extracted from the first image and placed in a smaller second image 1200. The irregular shape may be rotated such that it fits within an optimal shape for the second image 1200, such as a rectangle or square for the neural networks. Additionally, space around the irregular shape of the region 1102 may be filled with a default value, such as 0's to simplify multiplications in multiply-accumulate (MAC) operations.

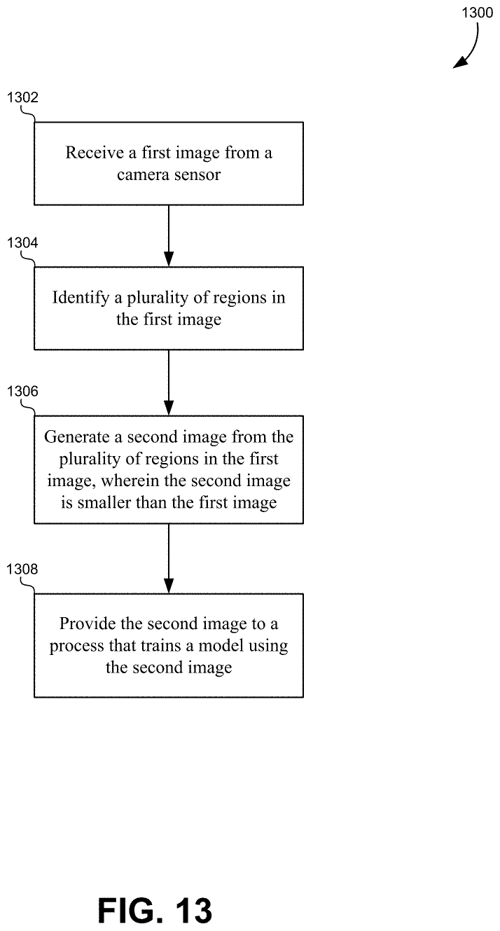

FIG. 13 illustrates a flowchart 1300 of a method for optimizing images, according to some embodiments. This method may be executed by dedicated logic in an ISP image pipeline, and thus may be performed by digital logic circuits in hardware on an ASIC or FPGA. Alternatively, some embodiments may execute this method in software on a CPU. Thus, this method may be stored in instructions that are executed by one or more processors.

The method may include receiving a first image from a camera sensor (1302). The first image may undergo pre-processing and/or post-processing operations in the image pipeline. The first image may be captured from a camera sensor that is stationary and which captures a predetermined view of a surrounding area. The first image may be received as described throughout this disclosure, including as described in relation to FIGS. 1, 3, 5, 7, 9, and 11.

The method may also include identifying a plurality of regions in the first image (1304). The plurality of regions may be predefined by storing locations of the regions using coordinates or other shape locations and images received from the camera sensor. When the first image is received, these predefined locations may be retrieved and used to identify the plurality of regions in the first image. Pixels from the plurality of regions may be extracted from the first image as areas of interest, or areas that are likely to include image features that a neural network in the ISP is trained to identify. The plurality of regions in the first image may be identified as described throughout this disclosure, including as described in relation to FIGS. 1, 3, 5, 7, 9, and 11.

The method may additionally include generating a second image from the plurality of regions in the first image (1306). In some embodiments, the second image may be smaller than the first image, such that the second image includes fewer pixels than the first image. The pixels in the plurality of regions from the first image may be extracted, rearranged, scaled, translated, rotated, etc., before being used to generate the second image. The second image may be generated to have a shape that is optimized for processing in a particular neural network, such as a rectangular shape, a square shape, and/or the like. Default values may be used to fill in extra pixels in the second image. The second image may be generated as described throughout this disclosure, including as described in relation to FIGS. 3, 6, 8, 10, and 12.

The method may further include providing the second image to a process that trains a model using the second image or process the second image using the model (1308). The model may include a neural network. Some embodiments may train the model using the second image, while some embodiments may additionally process the second image using the model to be processed by the model to identify features in the second image. For example, processing the second image using a neural network may include performing an inference operation that applies knowledge from the trained neural network model and uses the network to infer a result based on the second image. For example, this inference may include identifying an image feature or characteristic in the image, such as identifying the presence of a human or object in the image. Models such as neural networks may receive the second image for training and/or processing as described throughout this disclosure, including as described in relation to FIGS. 2 and 4.

It should be appreciated that the specific steps illustrated in FIG. 13 provide particular methods of optimizing an image according to various embodiments. Other sequences of steps may also be performed according to alternative embodiments. For example, alternative embodiments may perform the steps outlined above in a different order. Moreover, the individual steps illustrated in FIG. 13 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

FIG. 14 illustrates an exemplary computer system 1400, in which various embodiments may be implemented. The system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative embodiments of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain embodiments, processing unit 1404 may be implemented as one or more independent processing units 1432 and/or 1434 with single or multicore processors included in each processing unit. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, some or all of the program code to be executed can be resident in processor(s) 1404 and/or in storage subsystem 1418. Through suitable programming, processor(s) 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1400 may comprise a storage subsystem 1418 that comprises software elements, shown as being currently located within a system memory 1410. System memory 1410 may store program instructions that are loadable and executable on processing unit 1404, as well as data generated during the execution of these programs.

Depending on the configuration and type of computer system 1400, system memory 1410 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1404. In some implementations, system memory 1410 may include multiple different types of memory, such as static random access memory (SRAM) or dynamic random access memory (DRAM). In some implementations, a basic input/output system (BIOS), containing the basic routines that help to transfer information between elements within computer system 1400, such as during start-up, may typically be stored in the ROM. By way of example, and not limitation, system memory 1410 also illustrates application programs 1412, which may include client applications, Web browsers, mid-tier applications, relational database management systems (RDBMS), etc., program data 1414, and an operating system 1416. By way of example, operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1418 may also provide a tangible computer-readable storage medium for storing the basic programming and data constructs that provide the functionality of some embodiments. Software (programs, code modules, instructions) that when executed by a processor provide the functionality described above may be stored in storage subsystem 1418. These software modules or instructions may be executed by processing unit 1404. Storage subsystem 1418 may also provide a repository for storing data used in accordance with some embodiments.

Storage subsystem 1400 may also include a computer-readable storage media reader 1420 that can further be connected to computer-readable storage media 1422. Together and, optionally, in combination with system memory 1410, computer-readable storage media 1422 may comprehensively represent remote, local, fixed, and/or removable storage devices plus storage media for temporarily and/or more permanently containing, storing, transmitting, and retrieving computer-readable information.

Computer-readable storage media 1422 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1400.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments communications subsystem 1424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A system for optimizing images, the system comprising:
a camera sensor configured to capture a first image;
an image pipeline configured to:
receive the first image from the camera sensor;
identify a plurality of regions in the first image; and
generate a second image from the plurality of regions in the first image, wherein the second image is smaller than the first image; and
a neural network configured to receive the second image from the image pipeline and train the neural network using the second image or process the second image using the neural network.

2. The system of claim 1, wherein the image pipeline comprises an image preprocessor, an image post processor, and a double-data-rate (DDR) memory that stores the first image and the second image.

3. The system of claim 1, wherein the system further comprises one or more processors that receive the second image from the neural network or the image pipeline.

4. The system of claim 1, wherein a portion of the image pipeline that generates the second image is implemented in digital logic of an integrated circuit.

5. The system of claim 1, wherein a resolution of the first image is substantially the same as a resolution of the second image.

6. The system of claim 1, wherein a size of the second image is less than one tenth of a size of the first image.

7. The system of claim 1, wherein locations of the plurality of regions in the first image are predetermined prior to the first image being processed by the image pipeline and based on locations in a scene captured by the camera sensor.

8. The system of claim 7, wherein the locations in the scene captured by the camera sensor include objects that the neural network is trained to identify.

9. A method of optimizing images, the method comprising:
receiving a first image from a camera sensor;
identifying a plurality of regions in the first image;
generating a second image from the plurality of regions in the first image, wherein the second image is smaller than the first image; and
providing the second image to a process that trains a model using the second image or processes the second image using the model.

10. The method of claim 9, wherein generating the second image comprises:
rearranging locations of the plurality of regions from the first image to new locations in the second image.

11. The method of claim 9, wherein generating the second image comprises:
scaling at least one of the plurality of regions in the second image.

12. The method of claim 9, wherein generating the second image comprises:
storing a default value in remaining pixels in the second image that are not used by the plurality of regions.

13. The method of claim 9, wherein generating the second image comprises:
extracting pixels inside the plurality of regions in the first image; and
inserting the pixels into the second image.

14. The method of claim 9, wherein the second image excludes pixels in the first image that are outside of the plurality of regions.

15. A non-transitory computer-readable medium comprising instructions that, when executed by one or more processors, cause the one or more processors to perform operations comprising:
receiving a first image from a camera sensor;
identifying a plurality of regions in the first image;
generating a second image from the plurality of regions in the first image, wherein the second image is smaller than the first image; and
providing the second image to a process that trains a model using the second image or processes the second image using the model.

16. The non-transitory computer-readable medium of claim 15, wherein a shape of the second image is selected based on a shape for which the model is optimized.

17. The non-transitory computer-readable medium of claim 15, wherein generate the second image comprises:
applying a skew transform to at least one of the plurality of regions to correct a perspective difference between the plurality of regions.

18. The non-transitory computer-readable medium of claim 15, wherein at least one of the plurality of regions comprises a cutout.

19. The non-transitory computer-readable medium of claim 15, wherein the operations further comprise:
providing the second image to the model to identify features in the second image.

20. The non-transitory computer-readable medium of claim 15, wherein the plurality of regions in the first image are defined as areas in the view of the camera sensor that are likely to include objects that are recognized by the model.
